(19) United States
(12) Patent Application Publication
(10) Pub. No.: US 2003/0126240 A1
(43) Pub. Date: Jul. 3, 2003

(54) Method, system and computer program product for monitoring objects in an it network

(76) Inventor: Frank Vosseler, Altdorf (DE)

Correspondence Address: HEWLETT-PACKARD COMPANY, Intellectual Property Administration, P.O. Box 272400, Fort Collins, CO, 80527-2400, US

(21) Appl. No.: 10/318,210

(22) Filed: Dec. 13, 2002

(30) Foreign Application Priority Data
Dec. 14, 2001 (EP) 01 129 865.0

(51) Int. Cl. G06F 15/177

(52) U.S. Cl. 709/221

(57) ABSTRACT

Monitoring is performed of objects within an IT network having monitored nodes, at least one of which is a high-availability cluster having first and second cluster nodes. When a failover condition is detected for a cluster package at the first cluster node, a failover to the second cluster node is initiated. A monitoring agent system includes first and second agents associated with the first and second cluster nodes, respectively. The monitoring agent system monitors events relating to the cluster package and generates event-related messages. The agents receive information indicating whether the cluster package is currently active on the associated cluster node. Depending on the received information, the message generation relating to the cluster package is activated in the one of the agents which is associated with the cluster node on which the cluster package is currently active and is deactivated in the other one.

### FIELD OF THE INVENTION

The present invention relates generally to the monitoring of an information technological (IT) network, and more particularly to a method, system and a computer program product for monitoring objects in an IT network.

### BACKGROUND OF THE INVENTION

Nowadays, as information systems become ubiquitous, and companies and organizations of all sectors become drastically dependent on their computing resources, the requirement for the availability of the hardware components and software components (applications) of an IT network and of services based on it, (hereinafter all three are generally referred to as “objects”) is increasing while the complexity of IT networks is growing.

There are monitoring systems available which enable the availability and performance of objects within an IT network to be monitored and managed.

For example, Hewlett-Packard offers such a product family under the name “HP OpenView”. A personal computer, node, network interconnect device or any system with a CPU is called a node. The nodes of an IT network monitored by such a monitoring system are called monitored nodes. On a monitored node or somewhere in the network with access to the monitored node, a program or process runs as a background job which monitors the occurrence of certain events (e.g. application errors) at the node and generates event-related messages according to a “policy”, i.e. according to a set of instructions and/or rules which can be defined by a user. Such a program or process is called an “agent”. An agent is not limited to passive monitoring, e.g. by collecting error messages. Rather, it can carry out active monitoring of hardware and processes. For example, an agent can periodically (e.g. every five minutes) send requests to a process (e.g. an Oracle process) to find out whether the process is still running. A response saying that the process is no more running (or the absence of a response) may also constitute an “event”. The messages generated by the agents are collected by a monitoring server which stores and processes them and routes the processing results to a monitoring console by means of which an IT administrator or operator can view the status and/or performance of the IT objects.

A monitoring system of that kind increases the availability of the IT objects under consideration since it enables a fault or failure of a component of the monitored network to be quickly detected so that repair action or the like can immediately be started.

However, for many mission or business-critical applications, the level of availability achieved by monitoring alone is not sufficient. This class of services includes online transaction processing, electronic commerce, Internet/World Wide Web, data warehousing, decision support, telecommunication switches, Online Analytical Processing, and control systems. Such applications generally run 24 hours a day. The nodes on which these applications are executed must run perpetually and, therefore, demand high availability.

There are many different concepts for providing high availability IT services (see J. V. Carreira et al.: “Dependable Clustered Computing”, in: R. Buyya (Editor): High Performance Cluster Computing, Architectures and Systems, Vol. 1, 1999, pages 94-115). One of these concepts uses a cluster of at least two nodes. In what is called an active/standby configuration, one or more critical applications or parts of applications, run on one of the two nodes, the first or primary node. A cluster operating system checks permanently whether a “failover” condition (e.g. a failure or an error, which constitutes a forewarning of a failure, of the critical application or a hardware resource impairing it) has occurred. If such a failover condition in the primary node is detected, the critical application(s) is switched to the other node, the second or secondary node, thus avoiding downtime and guaranteeing the availability of the application(s), which is therefore also denoted as “protected application”. When the primary node has been repaired (after a failure), the critical application can be switched back from the secondary node to the primary node (see Carreira, pages 94-115, in particular pages 102-103). The application or part of an application which forms a logically connected entity in a “cluster view” and is switched from one the other node in the case of failover, is also called “cluster package”. Such HA clusters are advantageous compared to conventional specialized hardware-redundant platforms which are hardware-redundant on all levels (including power supplies, I/O ports, CPU's, disks, network adapters and physical networks) in order to individually eliminate any single point of failure within the platform, since they require the use of proprietary hardware and software. In contrast, the cluster solution allows users to take advantage of off-the-shelf industry standard and cheap components.

Clusters of nodes with cluster operating systems which observe the nodes and cause a failover if a failover condition is detected are, for example, known from WO 01/84313 A2, Z. Liang et al.: ClusterProbe: An Open, Flexible and Scalable Cluster Monitoring Tool, Proceedings. 1st IEEE Computer Society International Workshop, Melbourne, Australia, Dec. 2-3, 1999, ISBN 0-7695-0343-8/99, pp. 261-268, and U.S. Pat. No. 6,088,727.

The supervision performed by the cluster operating system as to whether a failover condition has occurred and the monitoring of the network objects carried out simultaneously and independently by the monitoring system have to be differentiated from each other, although sometimes a similar terminology is used. The first one is a specialized task carried out within the cluster by a cluster operating system to achieve high-availability of the cluster. The latter is a higher-level application (i.e. an application with much more interaction with users of the system than a cluster operating system) that monitors complex networks of single-system (i.e. non-cluster) nodes and cluster nodes .

Platform-independent network monitoring systems, such as the HP OpenView system, also allow the monitoring of such high availability (HA) clusters besides the monitoring of single-system nodes. Both cluster nodes are then provided with a respective agent. Each of these agents monitors the occurrence of events relating to the monitored application and generates event-related messages. Both agents permanently check whether the application under consideration is running. Since the monitored application runs only on one of the two cluster nodes at a time, one of the two agents permanently generates messages indicating that the application is not running, although it is intended that the application is not running on that node. The messages from both agents are processed upstream by the monitoring server which takes into account on which one of the two nodes the application is intended to be currently active. This way of processing the monitoring messages is relatively complicated.

In order to avoid the need for the monitoring server to process “false” error messages, a “work-around” solution has been proposed according to which the user can modify the cluster package software in such a way that it reconfigures both agents in the case of a failover so as to avoid the generation of “false” error messages.

### SUMMARY OF THE INVENTION

The invention provides a method of monitoring objects within an IT network which has monitored nodes and a monitoring agent system. At least one of the monitored nodes is an HA cluster comprising a first cluster node and a second cluster node. At least one cluster package is running on the high-availability cluster. When a failover condition is detected for a cluster package at the first cluster node, a failover to the second cluster node is initiated. The monitoring agent system comprises a first agent and a second agent associated with the first and second cluster node, respectively. The method comprises: The monitoring agent system monitors the occurrence of events relating to the cluster package and generates event-related messages for a monitoring server. The first and second agents receive information indicating whether the cluster package is currently active on the first or second cluster node respectively. Depending on that information, the message generation relating to the cluster package is activated in the one of the first and second agents associated with the cluster node on which the cluster package is currently active, and the message generation relating to the cluster package is de-activated in the other one of the first and second agents associated with the cluster node on which the cluster package is currently inactive.

According to another aspect, the invention provides a system for monitoring objects within an IT network having a monitoring server and monitored nodes. The system comprises at least one monitored node which is an HA cluster which comprises: a first cluster node and a second cluster node; a cluster operating system which initiates, when a failover condition is detected for a cluster package running on the first cluster node, a failover to the second cluster node; and an agent system which monitors the occurrence of events relating to the cluster package and generates event-related messages for the monitoring server, the agent system comprising a first agent and a second agent associated with the first and second cluster nodes, respectively. The first and second agents are arranged to receive information from the cluster operating system indicating whether the cluster package is currently active on the associated cluster node. The message generation relating to the cluster package is adapted to be, depending on that information, activated in the one of the first and second agents which is associated with the cluster node on which the cluster package is currently active and is de-activated in the other one.

According to still another aspect, the invention is directed to a computer program product including program code for execution on a network having a monitoring server and monitored nodes. At least one of the monitored nodes is an HA cluster having a first cluster node and a second cluster node. A cluster operating system initiates, when a failover condition is detected for a cluster package running on the first cluster node, a failover to the second cluster node. The program code, when executed, provides an agent system for monitoring the occurrence of events relating to the cluster package and generating event-related messages for the monitoring server. The agent system includes a first agent and a second agent associated with the first and second cluster nodes, respectively. The program code enables the first and second agents to receive information indicating whether the cluster package is currently active on the associated cluster node. The agents are arranged such that, depending on that information, the message generation relating to the cluster package is activated in the one of the first and second agents which is associated with the cluster node on which the cluster package is currently active and, the message generation relating to the cluster package is deactivated in the other one of the first and second agents which is associated with the cluster node on which the cluster package is currently inactive.

Other features are inherent in the disclosed method, system and computer program product or will become apparent to those skilled in the art from the following detailed description of embodiments and its accompanying drawings.

### DESCRIPTION OF THE DRAWINGS

In the accompanying drawings:

FIG. 1 shows a high-level architecture diagram of a monitored IT network;

FIGS. 2a, b illustrate a first preferred embodiment of a monitored HA cluster with one monitored cluster package;

FIGS. 3a, b illustrate a second preferred embodiment of a monitored HA cluster with two monitored cluster packages and a bi-directional failover functionality;

FIG. 4 is a flow chart of a method carried out by an agent in the embodiment of FIGS. 2a, b.

FIG. 5 illustrates an agent deployment process.

### DESCRIPTION OF THE PREFERRED EMBODIMENTS

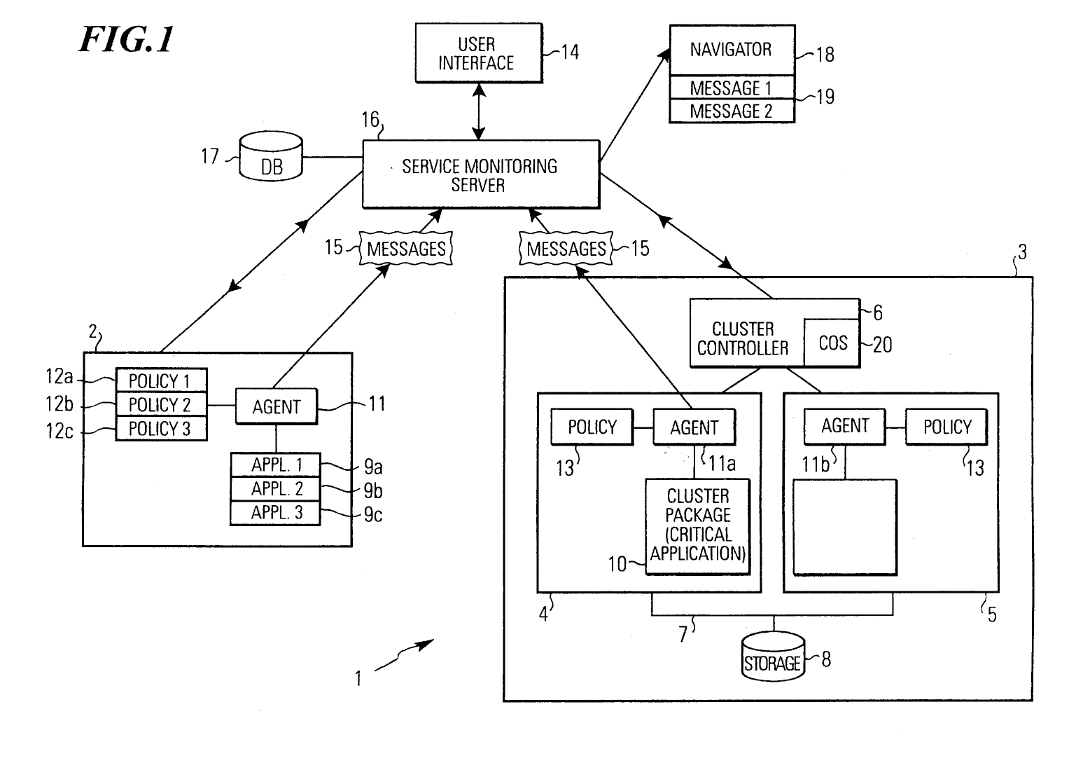

FIG. 1 shows a high-level architecture diagram of a preferred embodiment. Before proceeding further with the description, however, a few items of the preferred embodiments will be discussed.

In the preferred embodiments, objects of an information technical (IT) network are monitored as to their availability and performance by a network monitoring (or management) system. (The term “IT network” also includes telecommunication networks). Such monitored objects comprise hardware devices, software and services. A node is a network object such as a PC, node or any system with a CPU. A node is called a “monitored node” if it and/or applications or processes running on it are monitored by the monitoring system. Services are, for example, customer-based or user-oriented capabilities provided by one or more hardware or software components within a computing environment. For instance, services can be commercial applications (such as Oracle), Internet node applications (such as Microsoft Exchange), or internal (e.g. operating-system-related) services.

The monitoring may comprise passive monitoring (e.g. collecting error messages produced by the objects) or active monitoring (e.g. by periodically sending a request to the object and checking whether it responds and, if applicable, analyzing the contents of the response). Preferably, a monitoring of applications is carried out, rather than a simple resource monitoring. Besides pure monitoring tasks, in the preferred embodiments the monitoring system can also carry out management tasks, such as error correcting or fixing tasks, setting tasks and other network services control tasks.

An event is a (generally unsolicited) notification, such as an SNMP trap, CMIP notification or TL1 event, generated e.g. by a process in a monitored object or by a user action or by an agent. Typically, an event represents an error, a fault, change in status, threshold violation, or a problem in operation. For example, when a printer's paper tray is empty, the status of the printer changes. This change results in an event. An “event” may also be established by a certain state change in the monitored object detected by active monitoring.

An agent is a program or process running on a remote device or computer system. An agent communicates with other software, for example it responds to monitoring or management requests, performs monitoring or management operations and/or sends event notification. In the preferred embodiments, the agents are designed to run on the monitored nodes. In other preferred embodiment, the agents run nodes that are remote from the monitored node. There may be one agent for each monitored cluster package. In other embodiments, one agent can monitor several cluster packages. If several cluster packages or processes run on the same cluster node, they will be preferably monitored by one and the same agent associated with this cluster node. The agent is configured by a set of specifications and rules, called policy, for each cluster package application or process to be monitored. Policies can be user-defined. A policy tells the agent what to look for and what to do when an event occurs (and, what events to trigger, if the agent carries out active monitoring). For example, according to a particular policy, an agent filters events and generates messages which inform the monitoring server about the occurrence of certain events and/or the status and performance of the monitored application or process. The monitoring server collects event and performance data, processes them and routes the results to a monitoring console (a user interface). In the preferred embodiments, the monitoring server also centrally deploys policies, deployment packages, and agents, as directed by the user, and stores definitions and other key parameters. In the preferred embodiments, services are monitored platform-independently. For example, different operating systems can be implemented on the various monitored nodes.

In a high-availability (HA) cluster there is a primary node on which the critical application runs, and a secondary node which serves as a backup for the critical application. However, generally, only a part of one or more applications (for example, a part of an SAP application) runs on a cluster node and is backed up by the secondary node. The application or part of an application which forms a logically connected entity in a cluster view and is backed up, is also called “cluster package”. The two cluster nodes are interconnected. If a failover condition is detected, a cluster operating system initiates the switching of the critical application, the cluster package, from the primary to the secondary node. The HA cluster is transparent for the rest of the IT network in the sense that it appears to the “outside” as a corresponding standard (non-cluster) node.

A failover condition is a failure of the critical application or a resource, on which it depends, for example, if the critical application produces no or incorrect results, e.g. due to software faults (bugs) or due to hardware failures, such as a crash of a disk that the application needs. Preferably, a failover is initiated before such a serious failure occurs. This can be done if already a kind of forewarning, which is called an “error”, constitutes a failover condition. For example, some time before the external behavior of a system is affected, a part of its internal state may deviate from the correct value. If such an error is detected, which can be, for instance, an internal program variable with an invalid value, a failover can be carried out before the failure occurs. Another error which has such forewarning characteristics and can therefore be used as a failover condition is a decline in the performance of a hardware device.

In embodiments with only one monitored cluster package, or with several monitored cluster packages which, however, normally run on one and the same cluster node, the HA cluster is in an Active/Standby configuration. In this scheme, only the primary node is active, whereas the secondary node is in standby mode. The two machines do not need to be absolutely identical: The back-up machine just needs the necessary resources (disk, memory, connectivity etc.) to support the critical application(s). It can be a lower-performance machine as it only needs to keep the application(s) running while the primary node is repaired after a failover. Likewise, an Active/Active configuration can be used, wherein all nodes and the cluster are active and do not sit idle waiting for a failover to occur. For instance, an application A can run on node X and an application B on node Y. Then, node Y can backup the application A from node X, and node X can backup the application B from node Y. The solution is sometimes referred to as providing bidirectional failover. This Active/Active model can be extended to several active nodes that backup one another. However, it is common to these different models that, when referring to a particular application, one node can be considered active (this is the node on which the particular application is running) and the other node as being in the standby mode for this particular application. Therefore, in the present specification, the expression “the node is active/in the standby mode” means that it is active or in the standby with respect to a particular critical application cluster package under consideration, but does not necessarily mean that the machine itself is generally active or in the standby mode.

The HA clusters of the preferred embodiments can be likewise configured according to what is called the share-nothing cluster model or the share-storage cluster model. In the share-nothing cluster model, each cluster node has its own memory and is also assigned its own storage resources. Share-nothing clusters may allow the cluster nodes to access common storage devices or resources. In both models, a special storage interconnect can be used.

The HA clusters of the preferred embodiments use available cluster operating systems, such as Hewlett Packard MC/Serviceguard, Microsoft Cluster Node (formerly codenamed Wolfpack) or VeritasCluster. Further, for a particular application (such as Oracle Database) a definition has to be provided of what must happen when a failover occurs. Such software can- be considered as an interface between the cluster operating system and the particular critical application and forms part of the cluster package. For example, for the Oracle Database the corresponding software is “Oracle Clusterpackage”. Commonly, such “failover middleware” is a part of the respective critical application.

The supervision performed by the cluster operating system as to whether a failover condition has occurred and the monitoring of the network objects carried out simultaneously and independently by the monitoring system have to be differentiated from each other, although in the literature sometimes the same terminology (“monitoring”, “agents”, “server” ,etc.) is used. The first one is a specialized task carried out within the cluster by the cluster operating system to make services provided by the cluster highly available: The cluster operating system monitors by means of cluster operating system agents resources (disks, processors, memory, etc.) on each of the nodes of a cluster, and upon detection of a failure of a critical resource decides to fail-over (i.e. switch) the service (usually an application) from one machine (node) to another machine (node) of the cluster. I.e., in a cluster operating system, a network of nodes (single systems) is managed to “build” a cluster with the objective to expose a highly available “virtual node” to a user.

The monitoring or management systems of the preferred embodiments have a different focus—they manage a network of nodes (single-system nodes and/or multi-system virtual nodes (i.e. clusters)) with the objective to keep the overall distributed network infrastructure up and running. To manage such a mix of single-system nodes and multi-system virtual nodes (clusters), the cluster operating systems actually impose a challenge, as their failover of applications complicates the monitoring and configuration of the monitoring of these applications: for example, one can hardly use the standard configuration to monitor Oracle on a single system and deploy it to all machines that constitute a cluster. The usual approach to solve this is to use different monitoring configurations for Oracle running on single system and for Oracle running on a cluster at the cost of the end user having to maintain two sets of configuration. The concept of the preferred embodiments is to apply one and the same agent configuration on all nodes (including nodes that form a virtual node (i.e. a cluster), and to have the agent determine whether or not to use the configuration based on the cluster status obtained from cluster operating system.

Thus, the network monitoring application preferably is an operating-system-platform-independent application capable of monitoring complex networks as a whole and of being easily adapted to networks of different topologies. A network monitoring agent running on a node of a cluster may detect and report a failover and also a failover condition, but is not linked to the cluster operating system in such a way that it may cause a failover. Rather, it is used in addition to the cluster monitoring system agent and monitoring. In the present description, terms like “monitoring”, “agent”, “server”, “message”, “rules”, generally refer to network monitoring, not to cluster operating system monitoring.

In the preferred embodiments, the agent system comprises at least one agent for each cluster node of a monitored cluster. The agents actively or passively receive information indicating whether the cluster package is currently active on the associated cluster node. The monitoring and the receipt of this information are separate tasks which are carried out in parallel and independently. Based on this information, the message generation relating to the respective cluster package is activated or de-activated. An agent is activated to monitor the application (and, thus, generates monitoring messages) when the cluster package is active on the cluster node associated with the agent, and an agent is de-activated (and, thus, generates no erroneous monitoring messages indicating that the cluster package is unavailable) when the cluster package is unavailable on the cluster node associated with the agent. This solution can be based on standard agents and standard policies, such as those which can be used with non-cluster nodes, and does not require modifications of the cluster package software.

In the preferred embodiments, the agents receive this information from the cluster operating system. In order to receive said information, in one embodiment the agent periodically sends a corresponding request to the cluster operating system, and receives a corresponding response from it which indicates whether the associated cluster node is active or inactive. In another embodiment, the agent is registered at the cluster operating system upon initialization, which then notifies the agent periodically and/or in the case of a change about the activity status of the associated cluster package.

As already mentioned above, the expressions “active” and “inactive” or “standby” may refer either to a cluster node as a whole or a particular cluster package.

In the preferred embodiments, the agent of a cluster node generates messages according to monitoring rules. These rules can be defined by an user of the network management (or monitoring) system. In the most preferred embodiments, there is also at least one overlaid rule which pertains to cluster package activity. This rule is generally not part of the policy containing the user-definable monitoring rules, but it is associated with the policy and the monitored cluster package in the following manner: The overlaid rule causes the agent not to evaluate the monitoring rules (i.e. not to generate erroneous monitoring messages) if the information received from the cluster operating system indicates that the monitored cluster package is inactive on the associated cluster node.

In the preferred embodiments, the agents monitor the cluster package on the associated cluster nodes and generate messages according to a policy which includes monitoring rules. These rules can be defined by a user. The set of available rules for monitored clusters is preferably the same as (or at least comprises) the set of rules for monitored non-cluster nodes. In other words, a cluster is transparent for the user who wants to define rules for the monitoring task of an agent, i.e. it works with the same policy as a corresponding non-cluster node, so that the user does not have to define different versions of policies or rules for cluster and non-cluster nodes. The user can define the monitoring task (i.e. the policy/rules) for a monitored cluster as if it were a standard (non-cluster) node.

As mentioned above, there is a difference between monitoring non-cluster nodes and clusters: In the most preferred embodiments, an agent, which is associated with a cluster node in standby mode, generates no erroneous error messages indicating that the monitored cluster package is not running on that node, whereas an agent of a non-cluster node is commonly permanently ready to generate monitoring messages. Preferably, this functionality, i.e. the ability to communicate with the cluster operating system (i.e. the ability to receive said information) and to exhibit the above-described dependency of the message generation on the activity state of the associated cluster node with regard to the monitored cluster package is automatically provided upon the installation of the agent and/or the policies. Typically, a user indicates that a policy shall be installed on a certain node, i.e. he assigns the policy to the certain node. Since the network monitoring application or another application which controls the deployment of the policy to the agent on a node is aware of whether the certain node is a cluster node or a non-cluster node, it automatically activates, upon the installation of the policy, the overlaid rule, and the ability to communicate with the cluster operating system, when the policy is to be installed on a cluster node, and de-activates the overlaid rule and the ability to communicate with the cluster operating system, when the policy is to be installed on a non-cluster node. Thus, the cluster node is also transparent in the deployment process, i.e. it appears as a non-cluster node, so that the user does not have to deploy different version of policies for cluster and non-cluster nodes. (In some embodiments, the user may be required to expressly indicate to the system that the agent shall operate on a cluster node rather than on a non-cluster node).

The preferred embodiments of the computer program product comprise program code which, for example, is stored on a computer-readable data carrier or is in the form of signals transmitted over a computer network. The preferred embodiments of the program code are written in an object-oriented programming language (e.g. Java or C++). The program code can be loaded (if needed, after compilation) and executed in a digital computer or in networked computers, e.g. a monitoring server networked with monitored nodes.

In the preferred embodiments, the software has a central deployment functionality: the user can assign one or more policies to a monitored node from a user interface (console) and the program code automatically installs (“deploys”) the intelligent agents and policies at the cluster node. Upon installation the agents and/or policies are automatically adapted to the requirements of the monitored node. For example, the overlaid rule which obscures the package status by inactivating message generation is automatically added to the user-definable standard monitoring rules, and also the agent's interface to the cluster operating system for the receipt of the activity information which is one of the two types (periodical request or registration) is automatically installed or activated. Thus, the agent and policy deployment to a cluster is transparent (i.e. appears as an agent and policy deployment to a single node) for the user, and requires no additional manual intervention to adapt the agent or the policy to the sort of node (cluster node or non-cluster node).

Returning now to FIG. 1, it shows a high-level architecture diagram of a preferred embodiment of a service monitoring system 1. The system 1 comprises two monitored nodes, namely a non-cluster node 2 and a high-availability (HA) cluster 3. The HA cluster 3 has two nodes, a primary cluster node 4 and a secondary cluster node 5, as well as a cluster controller 6 with a cluster operating system (COS) 20, a storage interconnect 7 and a cluster storage 8. The node 2 and the HA cluster 3 are a part of a monitored IT network. Non-critical applications or services 9a-c run on the node 2. A critical application 10, also called cluster package, runs on the primary cluster node 4 of the HA cluster 3. A monitoring software component 11 (an “agent”) is installed on each of the monitored nodes 2, 4, 5 which runs automatically as a background task. The agents 11 receive event notifications and collect performance data from the monitored applications and services 9a-c, 10 and from hardware resources used by them. They collect and evaluate these event notifications and performance data according to policies 12a-c, 13. The policies comprise sets of collection and evaluation rules which are defined by a user via a user interface 14. Although there is only one agent 11 per monitored node 2, 4, 5, there is one policy 12, 13 per monitored application or cluster package 9, 10. Therefore, in FIG. 1 there are three policies 12a-12c associated with the agent 11 which monitors the three applications 9a-c, whereas there is only one policy 13 associated with the agent 11a since, in FIG. 1, it monitors only one application (cluster package) 10. It is likewise possible that several (1, 2, 3 . . . M) policies are associated with one application. For example, there may be one policy defining the monitoring of processes relating to the application, and another policy for defining the monitoring of the application's logfile.

Depending on which events occur and what is indicated by the collected data, the agents 11, 11a filter and evaluate them according to the policies 12, 13, and send monitoring messages 15 to a service monitoring server 16 which stores the messages in a monitoring database 17, processes them and sends the messages and the processing results to a navigator display 18 including a message browser 19. In the navigator display 18, the network and the services provided by it are visualized for the user in the form of a two-dimensional network and service map showing the status of the individual monitored services. In the message browser 19 the most relevant messages are displayed. The user can add rules by the user interface 14 which define how the service monitoring server 16 is to process the messages 15.

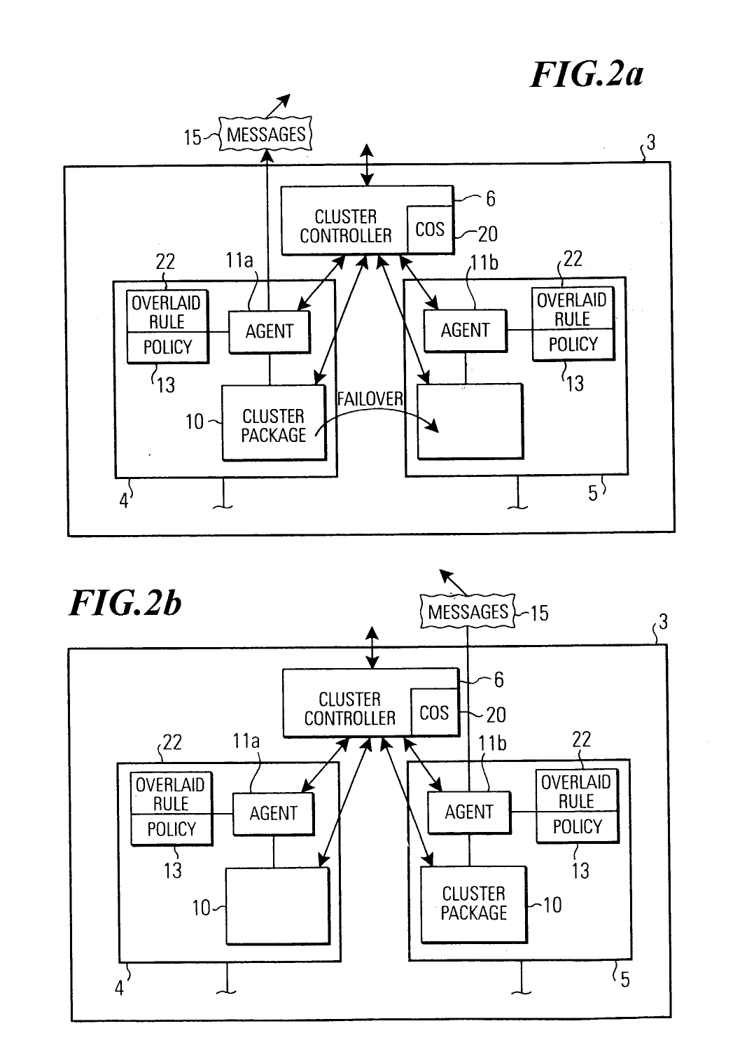

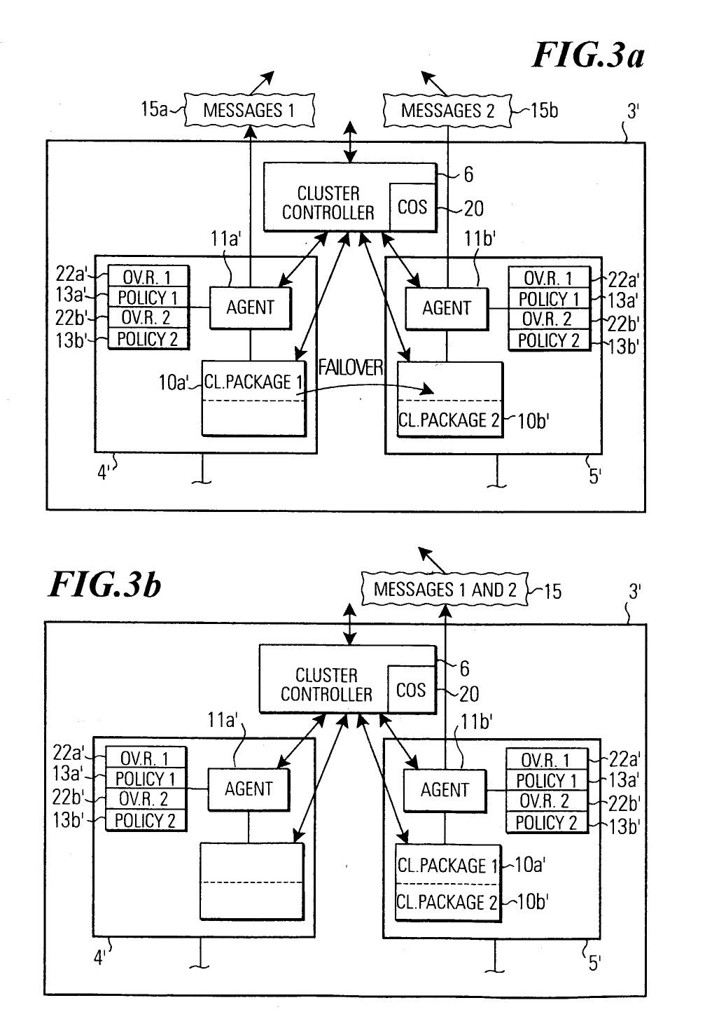

In the HA cluster 3, the cluster package 10 is shown to be active on the primary cluster node 4 and inactive on the secondary cluster node 5. Although an agent 11b is installed on the standby cluster node 5, it does not generate erroneous monitoring messages due to notification data received from the cluster operating system 20 which tell the agent 11b that the monitored cluster package 10 is currently inactive on its associated node 5. Rather, based on the notification data, only the agent 11 a associated with the cluster node 4 on which the cluster package 10 is currently active generates monitoring messages 15 relating to the cluster package 10. More detailed views of the HA cluster are shown in FIGS. 2 and 3.

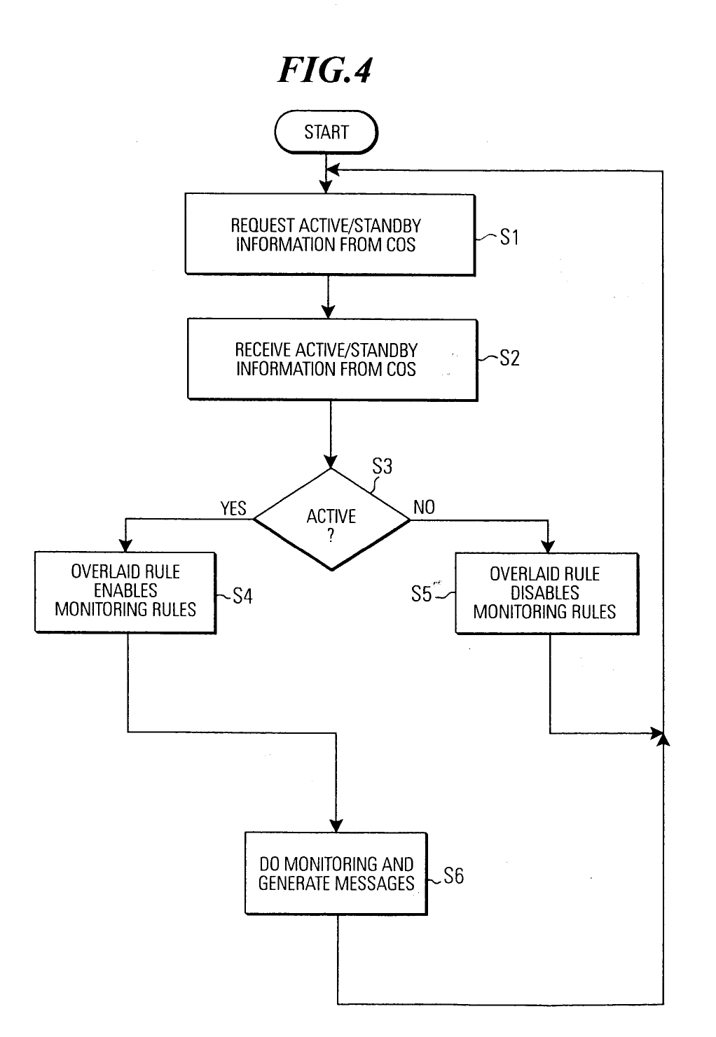

FIG. 2 illustrates the case of an HA cluster 3 with only one monitored cluster package 10 before (FIG. 2a) and after (FIG. 2b) a failover has been carried out. In the state before the failover, the cluster package 10 is active on the primary cluster node 4. It is inactive on the secondary node 5, but the secondary node 5 is ready to back it up from the primary node 4. An agent 11a is installed on the primary node 4, and another agent 11b is installed on the secondary node 5. A policy 13 for monitoring the cluster package 10 and an overlaid rule 22 are associated with each of the agents 11a, 11b. The policy 13 comprises monitoring rules, which define what and how to collect and how to generate monitoring messages. The overlaid rule 22 defines that no event collection and/or message generation shall be carried out when the associated cluster package is inactive. The cluster operating system 20 on the cluster controller 6 permanently checks the cluster package 10 on the active primary node 4 and resources on which the cluster package 10 depends for the appearance of a failover condition. The cluster operating system 20 also is in communication with the agents 11a, 11b. It is aware of on which one of the nodes 4, 5 the cluster package 10 is currently active and on which one it is inactive. There are two different embodiments of how the agents 11a, 11b can obtain this information pertaining to cluster-node activity (FIG. 4): According to a first embodiment, the agents 11a, 11b periodically send requests to the cluster operating system 20 which returns the requested activity/standby information. According to the other embodiment, the agents 11a, 11b are registered at the cluster operating system 20 once upon initialization, and then receive automatically a notification from the cluster operating system 20 when the activity/standby mode changes (and, optionally, also periodically status notifications). This second embodiment is preferred, however, it is not supported by all available cluster operating systems. In FIG. 2a, the agent 11a is notified (or informed by a response) that on its associated node 4 the cluster package 10 is active, whereas agent 11b is notified that on its associated node 5 the cluster package 10 is inactive. Accordingly, the overlaid rules 22 command the agent 11a to evaluate the monitoring rules defined in the policy 13 and the agent 11b not to evaluate these monitoring rules. Consequently the agent 11a of the node 4 on which the cluster package 10 is active generates monitoring messages 15, whereas agent 11b of the node 5 on which the cluster package 10 is inactive does not generate monitoring messages relating to the cluster package 10. The monitoring messages 15 generated by the active node's agent 11a are sent to the monitoring server 16 which uses them for monitoring the cluster 3. Thus, from outside the cluster 3 the messages 15 appear as if they came from a corresponding standard (non-cluster) node.

As mentioned above, the cluster operating system 20 checks the primary node 4 and the active cluster package 10 running on it for the appearance of a failover condition. Such a failover condition can be a failure of a hardware resource such as a LAN card, a hard disk, a CPU etc. Other failover conditions are software related. For instance, an electromagnetic interference, a program bug or a wrong command given by an operator may cause a program failure. Preferably, a failover condition is constituted not only of such serious failures, but already of errors which are forewarnings of a failure, such as a hardware performance degradation or the occurrence of an internal program variable with an invalid value. The cluster package 10 may be able to compensate for such errors and prevent the system from failing for a certain time so that the processing can be continued on the secondary node 5 practically interruption-free. The detection of such a hardware or software failure or error constitutes a failover condition. Upon its detection, the cluster controller 6 initiates the failover (indicated in FIG. 2a by an arrow). The secondary node 5 backs up the cluster package 10 automatically and transparently, without the need for administrator intervention or client manual reconnection. In the second embodiment, the agents 11a and 11b are notified by the cluster operating system 20 that a failover of the cluster package 10 from the primary node 4 to the secondary node 5 is carried out. In the first embodiment this information is only requested from the cluster operating system 20 which causes a small delay corresponding on average to half the request period.

FIG. 2b illustrates the situation after the failover. Now, the cluster package is running on the secondary node 5. The secondary node's agent 11b generates monitoring messages 15 based on the notification by the cluster operating system 20. The cluster package 10 on the primary node 4 is now in an error state and, thus, inactive. Owing to the notification by the cluster operating system 20, the agent 11a generates no erroneous messages indicating that the cluster package 10 on the primary node 4 is now in an error state. After the errors or faults that caused the failover have been detected and diagnosed, recovery, repair and reconfiguration actions may take place. Then the reversed process of failover, which is termed failback, can be carried out. It consists basically of moving back the critical application 10 to the primary node 4, about which the agents 11a and 11b are again notified. Then, the original message generation state is also re-established.

Preferably, both agents 11a, 11b are permanently active in order to perform monitoring of the first and second nodes 4, 5 themselves, even if the cluster package 10 is inactive on the respective node. This provides information as to whether the respective node is able to back up the cluster package in the case of a failover.

The failover capability can also be used efficiently for another important purpose: maintenance. Maintenance actions can be performed on the primary node by switching over the critical application to the secondary node. On-line maintenance of that kind reduces or even eliminates the need for scheduled down times for maintenance tasks and software upgrades.

The failover process commonly includes a number of resources to be switched over to the standby node. For example, the network identity of the nodes is switched. Using the TCP/IP protocol, this involves to dynamically change the IP address associated with the primary node's network card to that of the secondary node's network card.

The policy 13 with monitoring rules defined by the user for the monitoring of the application (cluster package) 10 is the same as that the user would have to define for a corresponding monitoring of the same application running on a standard (non-cluster) node. The installation of the two agents 11a, 11b at the primary and secondary nodes 4, 5 together with the policies 13 assigned to them is carried out automatically by the monitoring server 16, when the data model of the monitored IT network is configured so as to include the HA cluster 3. In particular, the user does not have to enter the overlaid rules 22. But rather, the overlaid rule 22 is already included in the program code representing the agents 11a, 11b, and is automatically activated by the monitoring server 16 upon installation (and is de-activated by the monitoring server 16 if the agent 11 is installed on a non-cluster node, such as node 2 of FIG. 1). The HA cluster 3 is thus transparent (e.g. it appears as a corresponding non-cluster node) for a user who installs and configures the monitoring system 1.

FIG. 3 illustrates the case of an HA cluster 3′ with two monitored cluster packages 10a′ and 10b′. Although it is possible to host two or more cluster packages in an active/standby configuration corresponding to what is illustrated in FIG. 2, FIG. 3 shows an alternative in the form of an active/active configuration. FIG. 3a illustrates the state of the HA cluster 3′ before and FIG. 3b after a failover has been carried out. The above description of FIGS. 1 and 2 applies also to FIG. 3; the only differences are described below.

With the active/active configuration of FIG. 3, it is avoided that the secondary node is normally idle and serves only for backup purposes. Rather, both nodes are normally active: a first monitored cluster package 10a′ runs on the primary node 4′, and a second monitored cluster package 10b′ runs on the secondary node 5′. The primary node 4′ is prepared to back up the second cluster package 10b′ from the secondary node 5′ in the case of a failover. Likewise, the secondary node 5′ is prepared to back up the first cluster package 10a′ from the primary node 4′ in the case of a failover (see Carreira, pages 102-103). A policy and an overlaid rule for each cluster package (here a policy 13a′ and a monitoring rule 22a for the first cluster package 10a′ and a policy 13b′ and a monitoring rule 22b′ for the second cluster package 10b′) are associated with each of the agents 11a′ and 11b′. Thus, in the example of FIG. 3 with two cluster packages 10a′, 10b′, each agent 11a′, 11b′ has two policies 13a′, 13b′, although only one cluster package 10a′ or 10b′ runs on each of the first and second nodes 4′, 5′. Each of the policies 13a′, 13b′ comprises, for each of the cluster packages 10a′, 10b′, a set of monitoring rules. In order to prevent the agents 11a′ and 11b′ from sending messages to the monitoring server 16 with regard to the one of the cluster packages 10b′, 10a′ which is intentionally not running on the respective node 4′, 5′, the primary node's agent 11a′ generates monitoring messages 15a only with regard to the first cluster package 10a′, but generates no monitoring messages with regard to the second cluster package 10b′. Correspondingly, the secondary node's agent 11b′ generates monitoring messages 15b only with regard to the second cluster package 10b′, but generates no monitoring messages with regard to the first cluster package 10a′. The mechanism for achieving that is the one described in connection with FIG. 2, however, the active/standby notifications or responses by the cluster operating system 20 are application-specific (of course, also in FIG. 2 the notifications or responses may be application-specific, although there is only one monitored cluster package).

In FIG. 3a, an arrow indicates that a failover is carried out in which the first cluster package 10a′ is switched from the primary node 4′ to the secondary node 5′. Owing to the bidirectional structure of the active/active configuration, a failover can also be carried out in the opposite direction, such that the second cluster package 10b′ is switched from the secondary node 5′ to the primary node 4′.

FIG. 3b illustrates the operating state of the cluster 3′ after the failover indicated in FIG. 3a has been carried out. Both cluster packages 10a′, 10b′ now run on the secondary node 5′, and the secondary node's agent 11b′ generates monitoring messages 15a, 15b for both cluster packages 10a′, 10b′. On the other hand, the cluster package 10a′ does not run on the primary node 4′ any more, and the primary node's agent 11a′ generates no error messages reflecting the fact that neither of the cluster packages 10a′, 10b′ is running on the primary node 4′. After the fault which has caused the failover has been repaired, the normal operational state according to FIG. 3a is restored by a failback.

The bidirectional active/active cluster of FIG. 3 with two nodes can be extended to a system with 3, 4 . . . N nodes, which is called an N-way cluster (see Carreira, pages 102-103). In such a system there may be a corresponding number of 3, 4 . . . N agents and, for each agent, a number of policies which corresponds to 1, 2, 3 . . . M times the total number of monitored cluster packages. The agents only generate monitoring messages with respect to the cluster package(s) running on the associated node, based on corresponding application-specific active/standby notifications or responses by the cluster operating system.

FIG. 4 illustrates a method carried out by each of the agents 11a, 11b, 11a′, 11b′ in FIGS. 2 and 3. In step S1, the agent 11a, 11b requests and receives active/standby information from the cluster operating system 20. In step S2 the agent receives the active/standby information. In step S3, the agent ascertains whether the monitored cluster package on the associated cluster node 4, 5, 4′, 5′ is active. If the answer is positive (which is, for example, true for the agent 11a in the operating state of FIG. 2a and for the agent 11b in the state in FIG. 2b), in step S4 the overlaid rule 22 enables (or maintains enabled) the monitoring rules. If the answer is negative (which is, for example, true for the agent 11b in the operating state of FIG. 2a and for the agent 11a in the one of FIG. 2b), in step S5 the overlaid rule 22 disables (or maintains disabled) the monitoring rules. In step S6 the agent carries out the monitoring task and generates monitoring messages according to the monitoring rules 13, provided that they have been enabled by the overlaid rule 22 in step S4. Step S6 can be repeated several times. Then, the flow proceeds further with step S1, thus forming a quasi-endless monitoring loop. When a failover is carried out, the path carried out by the first node's agent 11a in FIG. 2a switches from S3-S4-S6 to S3-S5, whereas the path of the second node's agent 11b switches from S3-S6 to S3-S4-S6. FIG. 4 illustrates the request/response embodiment—in the registration/notification embodiment step S1 is omitted.

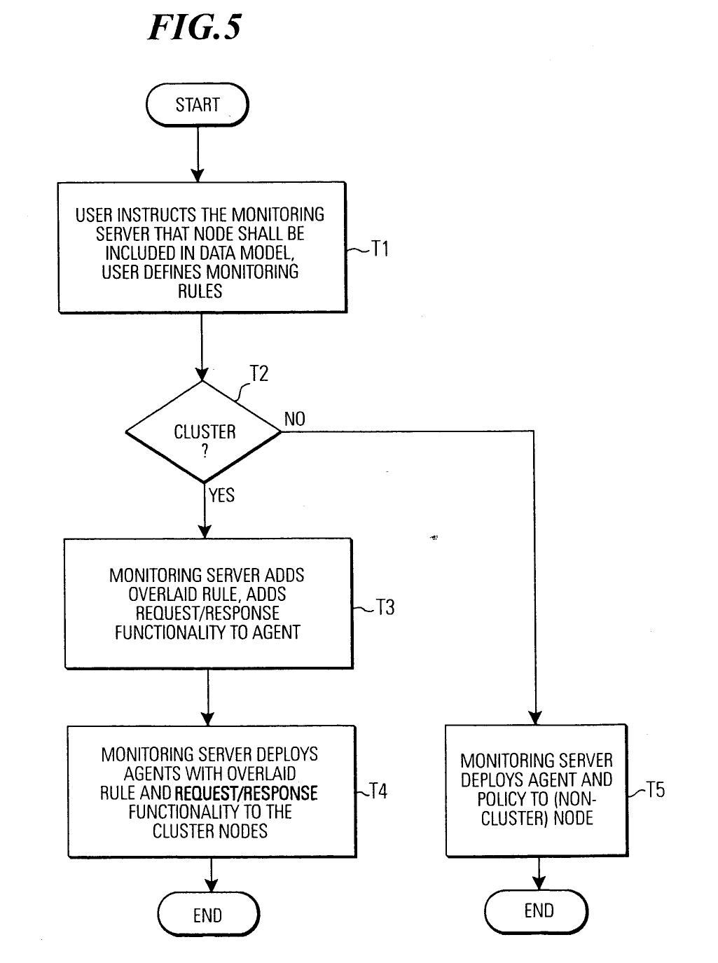

FIG. 5 illustrates a process in which agents, policies and overlaid rules are deployed by the monitoring server 16. In step T1, a user instructs the monitoring server 16 by means of the user interface 14 that a particular node (2 or 3) shall be included in the data model of the monitoring system 1. The user also defines a policy (monitoring rules) for that particular node. In step T2, the monitoring server 16 ascertains whether the node to be included is a standard (non-cluster) node, such as the node 2, or a cluster, such as the HA cluster 3. If the latter is true, in step T3 the monitoring server 16 adds the above-described request/response functionality to the agent software which is capable of monitoring the node and the critical application, and also adds the overlaid rule 22 to the standard policy 13. In some embodiments, the term “adding the functionality” or “adding the overlaid rule” actually means that the code providing the functionality or the rule is actually added to agent software (i.e. it is not present in agents deployed to non-cluster nodes), but in other preferred embodiments it means that the code providing the functionality or the rule is activated (i.e. it is also present in agents deployed to non-cluster nodes, but have no function there). Then, in step T4, the monitoring server deploys (i.e. installs) the agent together with the policy and the (activated) overlaid rule on each of the cluster nodes 4, 5 and the (activated) request/response functionality. If in step T2 it has turned out that the node to be included is a non-cluster node 2, then, in step T5, the monitoring server 16 deploys a standard agent with a standard policy to the node 2, i.e. the overlaid rule and the request/response functionality are not present or are de-activated. Again, FIG. 5 illustrates the request/response embodiment—in the registration/notification embodiment, in steps T3 and T4 the “response/request functionality” is replaced by the “notification functionality”, and a further step is included in the left-hand branch after step T2 (e.g. after step T4) in which the agents are registered at the cluster operating system. Thus, the system automatically takes into account whether or not a node is a cluster, when it deploys an agent to the node. In other words, for a user who wants to configure the monitoring system, a cluster is transparent i.e. can be configured like a non-cluster node.

Thus, a general purpose of the disclosed embodiments is to provide an improved method, computer system and computer program product for monitoring services in an IT network with monitored clusters, in which no erroneous messages stemming from inactive cluster nodes have to be processed, no change to the cluster package software is required and wherein the user can define the policies in the same way as he could for a corresponding monitoring task in a non-cluster node.

All publications and existing systems mentioned in this specification are herein incorporated by reference.

Although certain systems, methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method of monitoring objects within an information technological (IT) network having (a) monitored nodes, at least one of which is a high-availability cluster having a first cluster node and a second cluster node, wherein at least one cluster package is running on the high-availability cluster and, when a failover condition is detected for the cluster package at the first cluster node, a failover to the second cluster node is initiated, and (b) a monitoring agent system having a first agent and a second agent associated with the first and second cluster nodes, respectively, said method comprising:
the monitoring agent system monitors the occurrence of events relating to the cluster package and generates event-related messages for a monitoring server;
the first and second agents receive information indicating whether the cluster package is currently active on the first or second cluster node respectively;
wherein, depending on said information, (a) the message generation relating to the cluster package is activated in the one of the first and second agents associated with the cluster node on which the cluster package is currently active and (b) the message generation relating to the cluster package is de-activated in the other one of the first and second agents associated with the cluster node on which the cluster package is currently inactive.

2. The method of claim 1, wherein the agents receive said information from a cluster operating system of the high-availability cluster.

3. The method of claim 2, wherein the agents send requests for said information to the cluster operating system and receive corresponding responses from it.

4. The method of claim 2, wherein the agents receive said information in the form of notifications from the cluster operating system in at least one of the following ways: i) periodically, and ii) upon a change of the activity status of the cluster package.

5. The method of claim 1, wherein the agents generate messages according to monitoring rules, wherein there is also at least one overlaid rule pertaining to cluster package activity, according to which an agent does not evaluate the monitoring rules if said information indicates that the cluster package is inactive on the cluster node with which the agent is associated.

6. The method of claim 1, wherein the agents generate messages according to monitoring rules which can be defined by a user, wherein the set of available rules for monitored clusters is the same as or at least comprises the set of rules for monitored non-cluster nodes and wherein the user can define the monitoring task for a monitored cluster in the same way as for a non-cluster node.

7. The method of claim 6, wherein, upon installation, the agents that shall run on a monitored cluster are automatically configured such that they receive said information and exhibit said dependency of the message generation on said information.

8. The method of claim 1, wherein there is more than one monitored cluster package on the monitored node, and wherein, when the first cluster package is active on the first cluster node and the second cluster package is active on the second cluster node, the first agent is activated for the first cluster package and de-activated for the second cluster package and the second agent is activated for the second cluster package and de-activated for the first cluster package.

9. A system for monitoring objects within an information technological (IT) network having a monitoring server and monitored nodes, comprising:
at least one monitored node is a high-availability cluster which comprises:
a first cluster node and a second cluster node;
a cluster operating system which initiates, when a failover condition is detected for a cluster package running on the first cluster node, a failover to the second cluster node;
an agent system which monitors the occurrence of events relating to the cluster package and generates event-related messages for the monitoring server, the agent system comprising a first agent and a second agent associated with the first and second cluster nodes, respectively;
the first and second agents being arranged to receive information from the cluster operating system indicating whether the cluster package is currently active on the associated cluster node;
the message generation relating to the cluster package being adapted to be, depending on said information: (a) activated in the one of the first and second agents which is associated with the cluster node on which the cluster package is currently active and (b) de-activated in the other one.

10. The system of claim 9, wherein the agents are arranged to (a) send requests for said information to the cluster operating system and (b) receive corresponding responses from it.

11. The system of claim 9, wherein the agents are arranged to receive said information in the form of notifications from the cluster operating system in at least one of the following ways: i) periodically, and ii) upon a change of the activity status of the cluster package.

12. The system of claim 9, wherein the agents are arranged to (a) generate messages according to monitoring rules and (b) consider at least one overlaid rule pertaining to cluster package activity, such, that an agent does not evaluate the monitoring rules if said information indicates that the cluster package is inactive on the cluster node with which the agent is associated.

13. The system of claim 9, wherein the agents are arranged to generate messages according to monitoring rules which can be defined by a user, the set of available rules for monitored clusters being the same as or at least comprises the set of rules for monitored non-cluster nodes and wherein the user can define the monitoring task for a monitored cluster in the same way as for a non-cluster node.

14. The system of claim 13, wherein, upon installation, the agents that are assigned to operate on a monitored cluster are automatically configured such that they receive said information and exhibit said dependency of the message generation on said information.

15. A computer program product including program code for execution on a network having a monitoring server and monitored nodes, at least one of which is a high-availability cluster having a first cluster node and a second cluster node, wherein a cluster operating system initiates, when a failover condition is detected for a cluster package running on the first cluster node, a failover to the second cluster node,
said program code, when executed, provides an agent system for monitoring the occurrence of events relating to the cluster package and generating event-related messages for the monitoring server, wherein the agent system includes a first agent and a second agent associated with the first and second cluster nodes, respectively;
the program code enabling the first and second agents to receive information indicating whether the cluster package is currently active on the associated cluster node;
the agents being arranged such that, depending on said information, the message generation relating to the cluster package is activated in the one of the first and second agents which is associated with the cluster node on which the cluster package is currently active, and the message generation relating to the cluster package is de-activated in the other one of the first and second agents which is associated with the cluster node on which the cluster package is currently inactive.

16. The computer program product of claim 15, wherein the program code enables the agents to receive said information from the cluster operating system.

17. The computer program product of claim 16, wherein program code enables the agents to send requests for said information to the cluster operating system and to receive corresponding responses from it.

18. The computer program product of claim 16, wherein program code enables enables the agents to receive said information in the form of notifications from the cluster operating system in at least one of the following ways: i) periodically, and ii) upon a change of the activity status of the cluster package.

19. The computer program product of claim 15, wherein the agents provided by the program code generate messages according to monitoring rules, wherein there is at least one overlaid rule pertaining to cluster package activity, according to which an agent does not evaluate the monitoring rules if said information indicates that the cluster package is inactive on the cluster node with which the agent is associated.

20. The computer program product of claim 15, wherein the agents provided by the program code generate messages according to monitoring rules which can be defined by a user, wherein the set of available rules for monitored clusters is the same as or at least comprises the set of rules for monitored non-cluster nodes and wherein a user of the network is enabled to define the monitoring task for a monitored cluster in the same way as for a non-cluster node.

21. The computer program product of claim 20, wherein the program code causes the agents, upon installation, that are assigned to operate on a monitored cluster to be automatically configured such that they receive said information and exhibit said dependency of the message generation on said information.

22. The computer program product of claim 15, wherein there is more than one monitored cluster package on the monitored node, and wherein the agents are arranged such that, when the first cluster package is active on the first cluster node and the second cluster package is active on the second cluster node, the first agent is activated for the first cluster package and deactivated for the second cluster package and the second agent is activated for the second cluster package and de-activated for the first cluster package.
